(19) United States
(12) Patent Application Publication
(10) Pub. No.: US 2017/0004729 A1
(43) Pub. Date: Jan. 5, 2017

(54) MOTION ANALYSIS METHOD, MOTION ANALYSIS APPARATUS, MOTION ANALYSIS SYSTEM, AND PROGRAM

(71) Applicant: SEIKO EPSON CORPORATION, Tokyo (JP)

(72) Inventor: Toshihiko KANO, Minowa-machi (JP)

(73) Assignee: SEIKO EPSON CORPORATION, Tokyo (JP)

(21) Appl. No.: 15/114,257

(22) PCT Filed: Mar. 9, 2015
(86) PCT No.: PCT/JP2015/001248

§ 371 Date: Jul. 26, 2016

(30) Foreign Application Priority Data
Mar. 17, 2014 (JP) 2014-053333

(51) Int. Cl. G09B 19/00; A63B 69/36; G09B 5/12

(52) U.S. Cl. CPC G09B 19/0038; G09B 5/125; A63B 69/3632

(57) ABSTRACT

A motion analysis method, a motion analysis apparatus, a motion analysis system, and a program, capable of presenting useful information in order for a subject to improve a swing. A motion analysis method includes generating first position information regarding an ideal ball hitting position in a swing action performed by a subject with an exercise appliance, using outputs from an inertial sensor, generating second position information regarding a position of a hitting portion at the time of ball hitting of the subject, using outputs from the inertial sensor, and generating position difference information regarding a difference between the ideal ball hitting position and the position of the hitting portion at the time of ball hitting, using the first position information and the second position information.

### TECHNICAL FIELD

The present invention relates to a motion analysis method, a motion analysis apparatus, a motion analysis system, and a program, for analyzing motion of a subject.

### BACKGROUND ART

In the related art, there is a camera system in which an image of a golf swing is captured with a camera, and the swing is analyzed on the basis of the captured image, but, in such a camera system, since a large-scale apparatus is necessary, an installation location is selected, and thus simple measurement cannot be performed, and convenience deteriorates. In contrast, PTL 1 proposes an apparatus in which a three-axis acceleration sensor and a three-axis gyro sensor are attached to a golf club, and a swing is analyzed using outputs from the sensors, and, if the apparatus is used, a camera is not necessary, and convenience is improved. In a golf swing analysis apparatus using a sensor, information during impact can be presented, and a subject can understand whether or not the swing is an ideal swing which causes a ball to be hit in an aimed direction.

### CITATION LIST

### Patent Literature

PTL 1: JP-A-2008-73210

### SUMMARY OF INVENTION

### Technical Problem

However, a swing habit is greatly different for each person, and thus a concept of ideal swing is also different for each person. Thus, there is a problem in that, even if the subject understands that the swing is not an ideal swing on the basis of the information during impact, the subject is required to find an ideal swing suitable for the subject through trial and error.

The invention has been made in consideration of the above-described problems, and some aspects of the invention are to provide a motion analysis method, a motion analysis apparatus, a motion analysis system, and a program, capable of presenting useful information in order for a subject to improve a swing.

### Solution to Problem

The invention has been made in order to solve at least some of the above-described problems, and can be realized in the following aspects or application examples.

### APPLICATION EXAMPLE 1

A motion analysis method according to this application example includes generating first position information regarding an ideal ball hitting position in a swing action performed by a subject with an exercise appliance, using outputs from an inertial sensor; generating second position information regarding a position of a hitting portion of the exercise appliance at the time of ball hitting of the subject, using outputs from the inertial sensor; and generating position difference information regarding a difference between the ideal ball hitting position and the position of the hitting portion at the time of ball hitting, using the first position information and the second position information.

The exercise appliance is an appliance used to hit a ball, such as a golf club, a tennis racket, a baseball bat, and a hockey stick.

The inertial sensor may be a sensor which can measure an inertial amount such as acceleration or angular velocity, and may be, for example, an inertial measurement unit (IMU) which can measure acceleration or angular velocity. The inertial sensor may be attachable to and detachable, and may be fixed to an exercise appliance so as not to be detached therefrom, for example, as a result of being built into the exercise appliance.

The first position information may include, for example, at least one of coordinates of an ideal ball hitting position and a time point at which the exercise appliance is located at the ideal ball hitting position in a swing action. The second position information may include, for example, at least one of coordinates of the hitting portion at the time of ball hitting and a time point at which the subject has hit the ball.

According to the motion analysis method of this application example, it is possible to prompt the subject to improve a swing by presenting difference information between an ideal ball hitting position and an actual ball hitting position to the subject as useful information for improving the swing.

According to the motion analysis method of this application example, since attitude difference information can be generated using outputs from the inertial sensor attached to the exercise appliance, it is not necessary to prepare a large-sized measurement tool such as a camera, and a measurement location is not greatly limited.

### APPLICATION EXAMPLE 2

In the motion analysis method according to the application example, the ideal ball hitting position may be a position where an altitude of the hitting portion is lowest in the swing action.

According to the motion analysis method of this application example, it is possible to prompt the subject to improve a swing so that a swing trajectory is horizontal during ball hitting, by providing difference information between a position where an incidence angle in the vertical direction relative to a ball hitting position of the hitting portion is substantially 0° and an actual ball hitting position.

### APPLICATION EXAMPLE 3

In the motion analysis method according to the application example, in the generating of the first position information, trajectory information of the exercise appliance in the swing action may be generated using outputs from the inertial sensor, and the first position information may be generated using the trajectory information.

According to the motion analysis method of this application example, it is possible to relatively easily specify an ideal ball hitting position using trajectory information regarding the exercise appliance.

### APPLICATION EXAMPLE 4

In the motion analysis method according to the application example, in the generating of the second position information, a combined value of the outputs from the inertial sensor may be calculated, and the time of ball hitting may be specified on the basis of the combined value.

According to the motion analysis method of this application example, it is possible to relatively easily specify a timing at which the subject has hit the ball on the basis of the combined value of the outputs from the inertial sensor.

### APPLICATION EXAMPLE 5

The motion analysis method according to the application example may further include generating advice information regarding an address position of the subject for causing a position of the hitting portion at the time of ball hitting to become the ideal ball hitting position, using the position difference information.

According to the motion analysis method of this application example, the subject can specifically recognize an ideal address position on the basis of the advice information.

### APPLICATION EXAMPLE 6

In the motion analysis method according to the application example, the inertial sensor may be attached to the exercise appliance.

### APPLICATION EXAMPLE 7

In the motion analysis method according to the application example, the exercise appliance may be a golf club.

According to the motion analysis method of these application examples, it is possible to prompt the subject to improve a swing.

### APPLICATION EXAMPLE 8

A motion analysis apparatus according to this application example includes a first position information generation portion generating first position information regarding an ideal ball hitting position in a swing action performed by a subject with an exercise appliance, using outputs from an inertial sensor; a second position information generation portion generating second position information regarding a position of a hitting portion of the exercise appliance at the time of ball hitting of the subject, using outputs from the inertial sensor; and a position difference information generation portion generating position difference information regarding a difference between the ideal ball hitting position and the position of the hitting portion at the time of ball hitting, using the first position information and the second position information.

According to the motion analysis apparatus of this application example, it is possible to prompt the subject to improve a swing by presenting difference information between an ideal ball hitting position and an actual ball hitting position.

According to the motion analysis apparatus of this application example, since attitude difference information can be generated using outputs from the inertial sensor attached to the exercise appliance, it is not necessary to prepare a large-sized measurement tool such as a camera, and a measurement location is not greatly limited.

### APPLICATION EXAMPLE 9

A motion analysis system according to this application example includes the motion analysis apparatus described above; and the inertial sensor.

According to the motion analysis system of this application example, it is possible to prompt the subject to improve a swing by presenting difference information between an ideal ball hitting position and an actual ball hitting position.

### APPLICATION EXAMPLE 10

A program according to this application example causes a computer to execute generating first position information regarding an ideal ball hitting position in a swing action performed by a subject with an exercise appliance, using outputs from an inertial sensor; generating second position information regarding a position of a hitting portion of the exercise appliance at the time of ball hitting of the subject, using outputs from the inertial sensor; and generating position difference information regarding a difference between the ideal ball hitting position and the position of the hitting portion at the time of ball hitting, using the first position information and the second position information.

According to the program of this application example, it is possible to prompt the subject to improve a swing by presenting difference information between an ideal ball hitting position and an actual ball hitting position.

According to the program of this application example, since attitude difference information can be generated using outputs from the inertial sensor attached to the exercise appliance, it is not necessary to prepare a large-sized measurement tool such as a camera, and a measurement location is not greatly limited.

### BRIEF DESCRIPTION OF DRAWINGS

FIG. 1 is a diagram illustrating a motion analysis system according to the present embodiment.

FIG. 2 is a diagram illustrating an example of a position where and a direction in which a sensor unit is attached.

FIG. 3 is a diagram illustrating a procedure of actions performed by a subject in the present embodiment.

FIG. 4 is a diagram for explaining an attack angle.

FIG. 5 is a diagram illustrating a configuration example of a motion analysis system according to the present embodiment.

FIG. 6 is a flowchart illustrating examples of procedures of an advice information generation process in the present embodiment.

FIGS. 7(A) and 7(B) are diagrams illustrating an example of a relationship between a trajectory of a head of a golf club 3 and an actual ball hitting point.

FIGS. 8(A) and 8(B) are diagrams illustrating an example of a relationship between a trajectory of the head of the golf club 3 and an actual ball hitting point.

FIG. 9 is a flowchart illustrating examples of procedures of a process of detecting timing at which the subject has hit a ball.

FIG. 10(A) is a diagram in which three-axis angular velocities during swing are displayed in a graph, FIG. 10(B) is a diagram in which a calculated value of a norm of the three-axis angular velocities is displayed in a graph, and FIG. 10(C) is a diagram in which a calculated value of a derivative of the norm of the three-axis angular velocities is displayed in a graph.

FIG. 11 is a flowchart illustrating examples of procedures of a process of calculating an attitude of the sensor unit.

### DESCRIPTION OF EMBODIMENTS

Hereinafter, preferred embodiments of the invention will be described with reference to the drawings. The embodiments described below are not intended to improperly limit the content of the invention disclosed in the claims. In addition, all constituent elements described below are not essential constituent elements of the invention.

Hereinafter, a motion analysis system (motion analysis apparatus) analyzing a golf swing will be described as an example.

### 1. Motion Analysis System

### [Outline of Motion Analysis System]

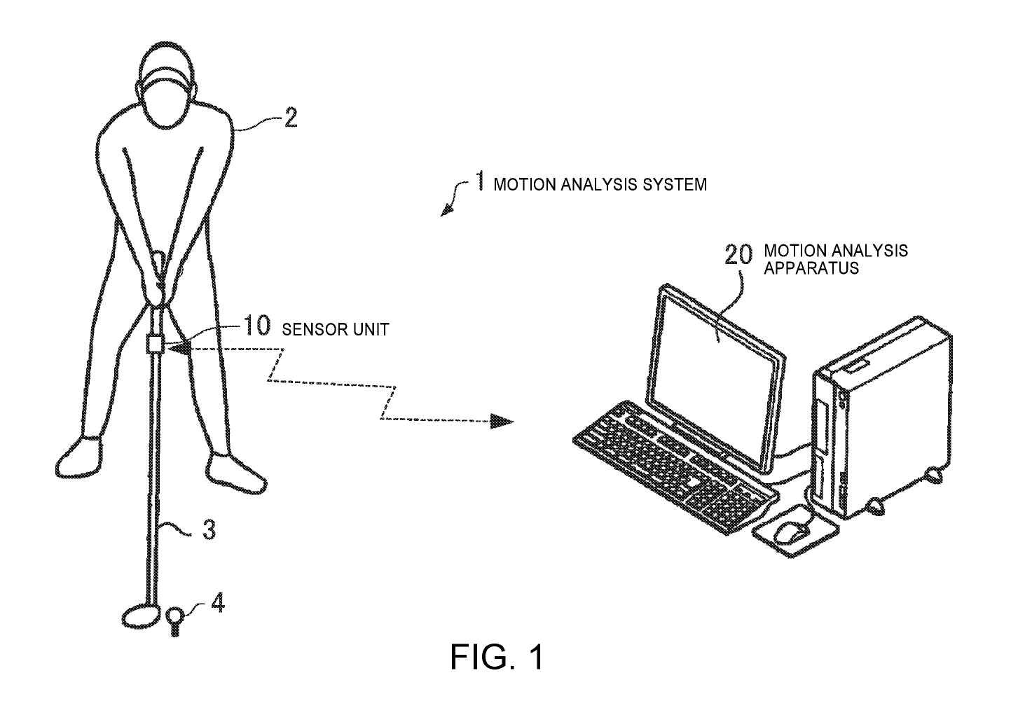

FIG. 1 is a diagram for explaining an outline of a motion analysis system according to the present embodiment. A motion analysis system 1 of the present embodiment is configured to include a sensor unit 10 (an example of an inertial sensor) and a motion analysis apparatus 20.

The sensor unit 10 can measure acceleration generated in each axial direction of three axes and angular velocity generated around each of the three axes, and is attached to the shaft of a golf club 3 (an example of an exercise appliance). The shaft is a shaft portion other than a head of the golf club 3 and also includes a grip portion.

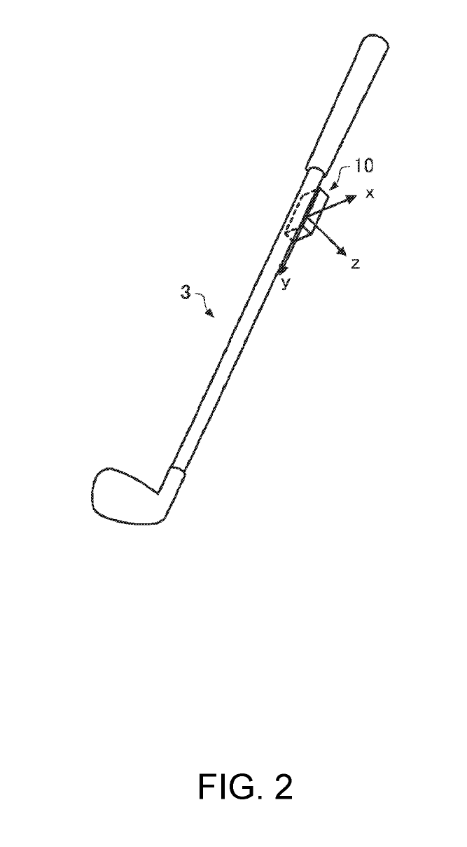

In the present embodiment, as illustrated in FIG. 2, the sensor unit 10 is attached so that one axis of three detection axes (an x axis, a y axis, and a z axis), for example, the y axis matches a long axis direction of the shaft.

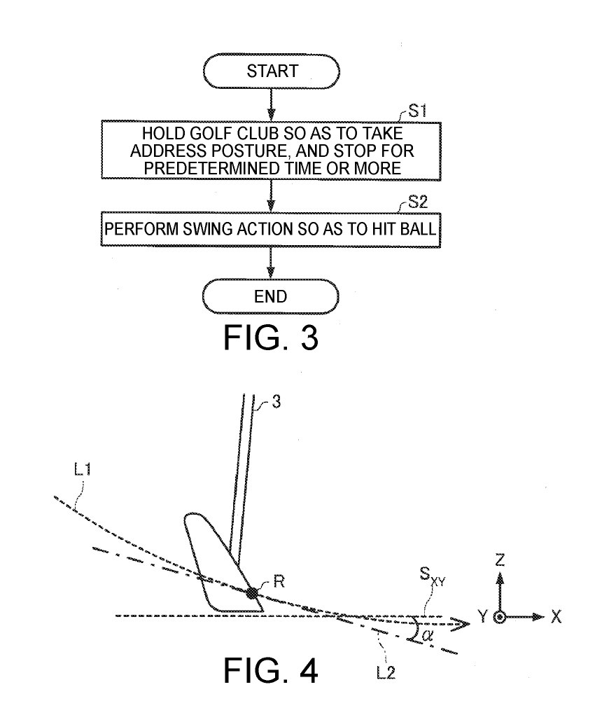

The subject 2 performs a swing action for hitting a golf ball 4 according to predefined procedures. FIG. 3 is a diagram illustrating procedures of actions performed by the subject 2. As illustrated in FIG. 3, first, the subject 2 holds the golf club 3 so as to take an address posture, and stops for a predetermined time period or more (for example, for one second or more) (S1). Next, the subject 2 performs a swing action so as to hit the golf ball 4 (S2).

While the subject 2 performs the action of hitting the golf ball 4 according to the procedures illustrated in FIG. 3, the sensor unit 10 measures three-axis acceleration and three-axis angular velocity at a predetermined cycle (for example, 1 ms), and sequentially transmits measured data to the motion analysis apparatus 20. The sensor unit 10 may instantly transmit the measured data, and may store the measured data in an internal memory and transmit the measured data at a desired timing such as completion of a swing action of the subject 2. Alternatively, the sensor unit 10 may store the measured data in an attachable/detachable recording medium such as a memory card, and the motion analysis apparatus 20 may read the measured data from the recording medium.

The motion analysis apparatus 20 generates information (first position information) regarding an ideal ball hitting position (ideal ball hitting point) in a swing action performed by the subject 2 with the golf club 3, and information (second position information) regarding a position (an actual ball hitting point) of the head of the golf club 3 when the subject 2 hits the ball, using the data measured by the sensor unit 10. The first position information may include, for example, position coordinates (three-dimensional coordinates in an XYZ coordinate system which will be described later) of an ideal ball hitting point, and may include the time at which an ideal ball hitting point occurs in a swing action. The second position information may include, for example, position coordinates of an actual ball hitting point, and may include the time at an actual ball hitting point (impact time).

The motion analysis apparatus 20 generates information (position difference information) regarding a difference between an ideal ball hitting position (ideal ball hitting point) and a position (actual ball hitting point) of the head of the golf club 3 during ball hitting, using the first position information and the second position information. The position difference information may be, for example, differences between position coordinates of an ideal ball hitting point and position coordinates of an actual ball hitting point, and it can be said that, if the difference between position coordinates is close to 0, an ideal swing occurs.

The motion analysis apparatus 20 generates advice information regarding an address position of the subject 2 using the position difference information so that a position of the head of the golf club 3 during ball hitting of the subject 2 becomes an ideal ball hitting position, and presents the advice information to the subject 2 with an image, sound, vibration, or the like.

Communication between the sensor unit 10 and the motion analysis apparatus 20 may be wireless communication, and may be wired communication.

In the present embodiment, a position where an attack angle is substantially 0° is an ideal ball hitting point. FIG. 4 is a diagram for explaining definition of the attack angle. In the present embodiment, an XYZ coordinate system is defined which has a target line indicating a hit ball direction as an X axis, an axis on a horizontal plane which is perpendicular to the X axis as Y axis, and a vertically upward direction (a direction opposite to the gravitational acceleration direction) as a Z axis. FIG. 4 illustrates the X axis, the Y axis, and the Z axis. The target line indicates, for example, a direction in which a ball flies straight. In FIG. 4, a point R indicates a ball hitting point at which the head of the golf club 3 comes into contact with a ball, a curve L1 indicates a part of the trajectory during swing of the head of the golf club 3, and a straight line L2 is a tangential line of the curve L1 at the ball hitting point R in an XZ plane. As illustrated in FIG. 4, an attack angle is defined as an angle α of the straight line L2 relative to an XY plane S_{XY}. In the present embodiment, in a case where a slope of the straight line L2 has a negative value (a case illustrated in FIG. 4), the attack angle α is a negative value, and in a case where a slope of the straight line L2 has a positive value, the attack angle α is a positive value. In other words, during down-blow in which the head is incident to the ball hitting point R obliquely downwardly, the attack angle α is smaller than 0°, during level-blow in which the head is incident to the ball hitting point R horizontally, the attack angle α is 0°, and during upper-blow in which the head is incident to the ball hitting point R obliquely upwardly, the attack angle α is larger than 0°.

When the ball hitting point R matches the lowest position (the lowest point at which a Z coordinate is smallest) on the trajectory of the head of the golf club 3 in a swing action, the attack angle α is substantially 0°. In other words, in the present embodiment, the lowest point on the trajectory of the head of the golf club 3 is an ideal ball hitting point.

### [Configuration of Motion Analysis System]

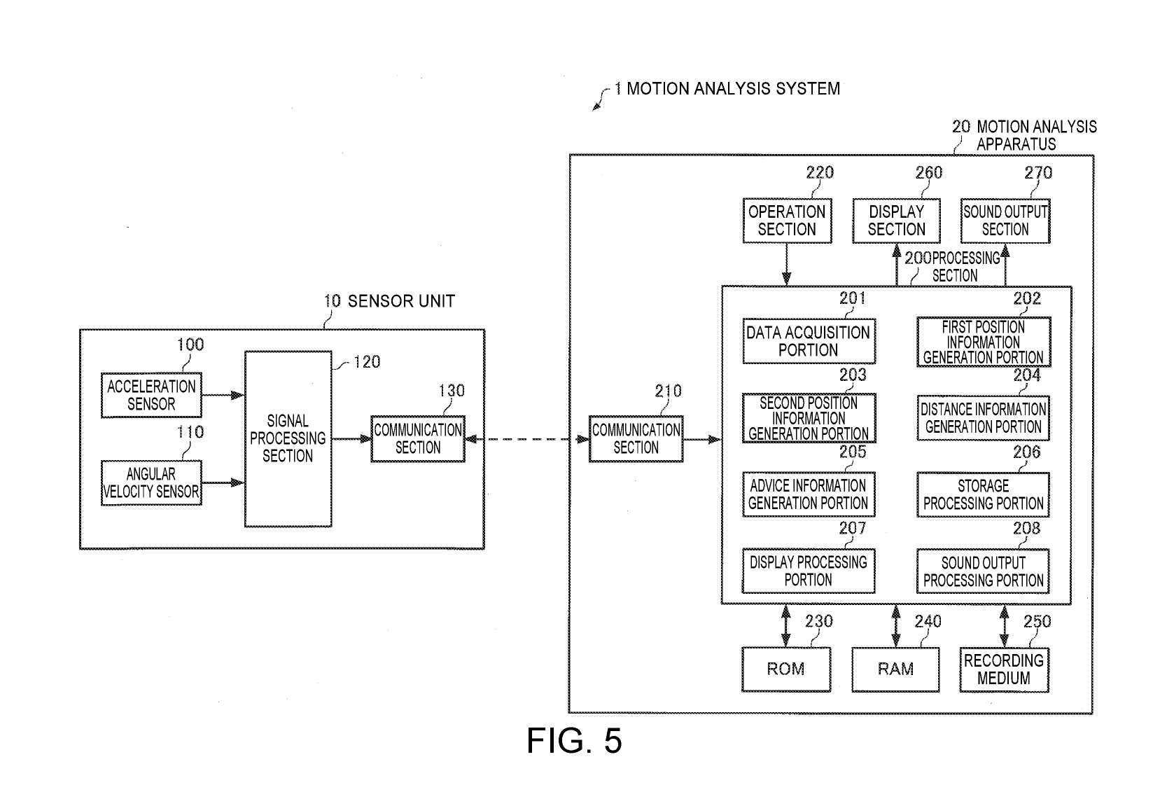

FIG. 5 is a diagram illustrating configuration examples of the sensor unit 10 and the motion analysis apparatus 20. As illustrated in FIG. 5, in the present embodiment, the sensor unit 10 is configured to include an acceleration sensor 100, an angular velocity sensor 110, a signal processing section 120, and a communication section 130.

The acceleration sensor 100 measures respective accelerations in three axial directions which intersect (ideally, orthogonal to) each other, and outputs digital signals (acceleration data) corresponding to magnitudes and directions of the measured three-axis accelerations.

The angular velocity sensor 110 measures respective angular velocities in three axial directions which intersect (ideally, orthogonal to) each other, and outputs digital signals (angular velocity data) corresponding to magnitudes and directions of the measured three-axis angular velocities.

The signal processing section 120 receives the acceleration data and the angular velocity data from the acceleration sensor 100 and the angular velocity sensor 110, respectively, adds time information thereto, stores the data in a storage portion (not illustrated), adds time information to the stored measured data (the acceleration data and the angular velocity data) so as to generate packet data conforming to a communication format, and outputs the packet data to the communication section 130.

Ideally, the acceleration sensor 100 and the angular velocity sensor 110 are provided in the sensor unit 10 so that the three axes thereof match three axes (an x axis, a y axis, and a z axis) of an orthogonal coordinate system defined for the sensor unit 10, but, actually, errors occur in installation angles. Therefore, the signal processing section 120 performs a process of converting the acceleration data and the angular velocity data into data in the xyz coordinate system using a correction parameter which is calculated in advance according to the installation angle errors.

The signal processing section 120 performs a process of correcting the temperatures of the acceleration sensor 100 and the angular velocity sensor 110. The acceleration sensor 100 and the angular velocity sensor 110 may have a temperature correction function.

The acceleration sensor 100 and the angular velocity sensor 110 may output analog signals, and, in this case, the signal processing section 120 may A/D-convert an output signal from the acceleration sensor 100 and an output signal from the angular velocity sensor 110 so as to generate measured data (acceleration data and angular velocity data), and may generate communication packet data using the data.

The communication section 130 performs a process of transmitting packet data received from the signal processing section 120 to the motion analysis apparatus 20, or a process of receiving a control command from the motion analysis apparatus 20 and sending the control command to the signal processing section 120. The signal processing section 120 performs various processes corresponding to control commands.

The motion analysis apparatus 20 is configured to include a processing section 200, a communication section 210, an operation section 220, a ROM 230, a RAM 240, a recording medium 250, a display section 260, and a sound output section 270, and may be, for example, a personal computer (PC) or a portable apparatus such as a smart phone.

The communication section 210 performs a process of receiving packet data transmitted from the sensor unit 10 and sending the packet data to the processing section 200, or a process of transmitting a control command from the processing section 200 to the sensor unit 10.

The operation section 220 performs a process of acquiring operation data from a user and sending the operation data to the processing section 200. The operation section 220 may be, for example, a touch panel type display, a button, a key, or a microphone.

The ROM 230 stores a program for the processing section 200 performing various calculation processes or a control process, or various programs or data for realizing application functions.

The RAM 240 is used as a work area of the processing section 200, and is a storage section which temporarily stores a program or data read from the ROM 230, data which is input from the operation section 220, results of calculation executed by the processing section 200 according to various programs, and the like.

The recording medium 250 is a nonvolatile storage section storing data which is required to be preserved for a long period of time among data items generated through processing of the processing section 200. The recording medium 250 may store a program for the processing section 200 performing various calculation processes and a control process, or various program or data for realizing application functions.

In the present embodiment, the ROM 230, the RAM 240, or the recording medium 250 stores specification information regarding the golf club 3 (information regarding a length of the shaft, a position of the centroid thereof, a lie angle, a face angle, a loft angle, and the like), an installation position (a distance from the head or the grip end of the golf club 3) regarding the sensor unit 10, and information regarding a length of the arm or a position of the centroid of the subject 2, and this information is used by the processing section 200.

The display section 260 displays a processing result in the processing section 200 as text, a graph, a table, animation, and other images. The display section 260 may be, for example, a CRT, an LCD, a touch panel type display, and a head mounted display (HMD). A single touch panel type display may realize functions of the operation section 220 and the display section 260.

The sound output section 270 displays a processing result in the processing section 200 as a sound such as a voice or a buzzer sound. The sound output section 270 may be, for example, a speaker or a buzzer.

The processing section 200 performs a process of transmitting a control command to the sensor unit 10 according to a program stored in the ROM 230 or the recording medium 250, or a program which is received from a server via a network and is stored in the RAM 240 or the recording medium 250, various calculation processes on data which is received from the sensor unit 10 via the communication section 210, and various control processes. Particularly, by executing the program, in the present embodiment, the processing section 200 functions as a data acquisition portion 201, a first position information generation portion 202, a second position information generation portion 203, a position difference information generation portion 204, an advice information generation portion 205, a storage processing portion 206, a display processing portion 207, and a sound output processing portion 208.

The data acquisition portion 201 performs a process of receiving packet data which is received from the sensor unit 10 by the communication section 210, acquiring time information and measured data from the received packet data, and sending the time information and the measured data to the storage processing portion 206.

The storage processing portion 206 performs a process of receiving the time information and the measured data from the data acquisition portion 201 and storing the time information and the measured data in the RAM 240 in correlation with each other.

The first position information generation portion 202 performs a process of generating first position information regarding an ideal ball hitting position (ideal ball hitting point) using the measured data (the acceleration data and the angular velocity data) output from the sensor unit 10. In the present embodiment, the ideal ball hitting point is assumed to be the lowest point of the head of the golf club 3 during swing action.

Specifically, the first position information generation portion 202 detects the stoppage action (the action in step S1 in FIG. 3) performed by the subject 2 before starting a swing action, in correlation with the time, using the time information and the measured data stored in the RAM 240. The first position information generation portion 202 calculates an offset amount using the measured data during stoppage, subtracts the offset amount from the measured data so as to perform bias correction, and calculates a position and an attitude (an initial position and an initial attitude) of the sensor unit 10 during address (stoppage action) of the subject 2 using the bias-corrected measured data. The first position information generation portion 202 may set an initial position of the sensor unit 10 to the origin (0,0,0) of the XYZ coordinate system, and may calculate an initial attitude of the sensor unit 10 on the basis of acceleration data and a direction of the gravitational acceleration during address (during stoppage action) of the subject 2. An attitude of the sensor unit 10 may be expressed by, for example, rotation angles (a roll angle, a pitch angle, and a yaw angle) around the X axis, the Y axis, and the Z axis, or a quaternion.

The first position information generation portion 202 calculates a position and an attitude of the sensor unit 10 during swing action (during the action in step S2 in FIG. 3) of the subject 2 using the time information and the measured data stored in the RAM 240. The first position information generation portion 202 may integrate the acceleration data so as to calculate a position change from the initial position of the sensor unit 10 in a time series, and may perform rotation calculation using the angular velocity data so as to calculate an attitude change from the initial attitude of the sensor unit 10 in a time series. The first position information generation portion 202 defines a motion analysis model in which a length and a position of the centroid of the shaft of the golf club 3, an installation position of the sensor unit 10, features (rigid body) of the golf club 3, or human features (a joint bending direction, and the like) are taken into consideration, and calculates a trajectory of the motion analysis model using information regarding the position and the attitude of the sensor unit 10, the length and the position of the centroid of the shaft of the golf club 3, the installation position of the sensor unit 10, and features (the length of the arm, the position of the centroid, and the like) of the subject 2. The first position information generation portion 202 calculates position coordinates when the head of the golf club 3 comes to the lowest position on the basis of the trajectory of the motion analysis model, so as to generate the first position information.

The signal processing section 120 of the sensor unit 10 may calculate an offset amount of measured data so as to perform bias correction on the measured data, and the acceleration sensor 100 and the angular velocity sensor 110 may have a bias correction function. In this case, it is not necessary for the first position information generation portion 202 to perform bias correction on the measured data.

The second position information generation portion 203 performs a process of generating second position information regarding a position (actual ball hitting point) of the head of the golf club 3 during ball hitting of the subject 2, using the measured data (at least one of the acceleration data and the angular velocity data) output from the sensor unit 10. Specifically, the second position information generation portion 203 detects a timing (time point) at which the subject 2 has hit the ball in a period of the swing action using the time information and the measured data stored in the RAM 240, and calculates position coordinates of an actual ball hitting point on the basis of the trajectory of the motion analysis model.

The position difference information generation portion 204 performs a process of generating position difference information regarding a difference between an ideal ball hitting point and an actual ball hitting point using the first position information generated by the first position information generation portion 202 and the second position information generated by the second position information generation portion 203. Specifically, the position difference information generation portion 204 calculates differences between coordinates (for example, an X coordinate and a Z coordinate) of the lowest point (ideal ball hitting point) of the head of the golf club 3 and coordinates (for example, an X coordinate and a Z coordinate) of an actual ball hitting point, and generates position difference information including the differences between the coordinates.

The first position information generation portion 202 may calculate a time point at which the head of the golf club 3 comes to the lowest point on the basis of the trajectory of the motion analysis model, and generate first position information including the time point, and the second position information generation portion 203 may calculate a time difference from the lowest point to an actual ball hitting point (or from the actual ball hitting point to the lowest point) and a velocity vector of the head of the golf club 3 on the basis of the trajectory of the motion analysis model, and generate second position information including the information. In this case, the position difference information generation portion 204 may calculate differences between coordinates of the lowest point and coordinates of the actual ball hitting point by multiplying the time difference from the lowest point to the actual ball hitting point (or the actual ball hitting point to the lowest point) by the velocity vector, and generate position difference information including information regarding the coordinate differences.

The advice information generation portion 205 performs a process of generating advice information regarding an address position of the subject 2 for causing a position of the head of the golf club 3 to be an ideal ball hitting point during ball hitting of the subject 2, using the position difference information generated by the position difference information generation portion 204. Specifically, predetermined calculation is performed using the coordinate differences between the lowest point (ideal ball hitting point) of the head of the golf club 3 and an actual ball hitting point, and advice information indicating at which position the subject 2 is addressed is generated in order to match a position of the head of the golf club 3 with the ideal ball hitting point during ball hitting.

The advice information generation portion 205 may generate advice information such as the content that “step backward (forward) by 3 cm for addressing”, or “deviate to the right (to the left) by 3 cm for addressing”. For example, a buzzer or an LED may be provided in the sensor unit 10 or the motion analysis apparatus 20, and the advice information generation portion 205 may generate advice information such as the content that “step backward (forward) until the buzzer sounds (until the LED is turned on)”, or “deviate to the right (to the left) until the buzzer sounds (until the LED is turned on)”.

An optimal address position of the subject 2 differs depending on the type of golf club 3, physical features of the subject 2, a swing habit, or the like, and thus the advice information generation portion 205 may perform predetermined calculation in which features of the golf club 3 or information regarding a trajectory of the motion analysis model is also taken into consideration, so as to generate advice information.

The storage processing portion 206 performs read/write processes of various programs or various data for the ROM 230, the RAM 240, and the recording medium 250. The storage processing portion 206 performs not only the process of storing the time information and the measured data received from the data acquisition portion 201 in the RAM 240 in correlation with each other, but also a process of storing the first position information, the second position information, the position difference information, the advice information, and the like in the RAM 240, or a process of storing the information in the recording medium 250 in a case where the information is desired to be kept as a record.

The display processing portion 207 performs a process of displaying various images (including text, symbols, and the like) on the display section 260. For example, the display processing portion 207 performs a process of reading the advice information stored in the RAM 240 or the recording medium 250 automatically or when a predetermined input operation is performed after a swing action of the subject 2 is completed, and displaying an advice image on the display section 260. The display processing portion 207 may read the first position information, the second position information, the position difference information, and the like stored in the RAM 240 or the recording medium 250, and may display various images on the display section 260. Alternatively, a display section may be provided in the sensor unit 10, and the display processing portion 207 may transmit an advice image or the like to the sensor unit 10 via the communication section 210, and the advice image or the like may be displayed on the display section of the sensor unit 10.

The sound output processing portion 208 performs a process of outputting various sounds (including voices, buzzer sounds, and the like) from the sound output section 270. For example, the sound output processing portion 208 may read the advice information stored in the RAM 240 or the recording medium 250 automatically or when a predetermined input operation is performed after a swing action of the subject 2 is completed, and may output an advice sound from the sound output section 270. The sound output processing portion 208 may read the first position information, the second position information, the position difference information, and the like stored in the RAM 240 or the recording medium 250, and may output various sounds from the sound output section 270. Alternatively, a sound output section may be provided in the sensor unit 10, and the sound output processing portion 208 may transmit an advice sound or the like to the sensor unit 10 via the communication section 210, and may output the advice sound or the like from the sound output section of the sensor unit 10.

A vibration mechanism may be provided in the motion analysis apparatus 20 or the sensor unit 10, and the advice information or the like may be converted into vibration information by the vibration mechanism so as to be presented to the subject 2.

### [Advice Information Generation Process]

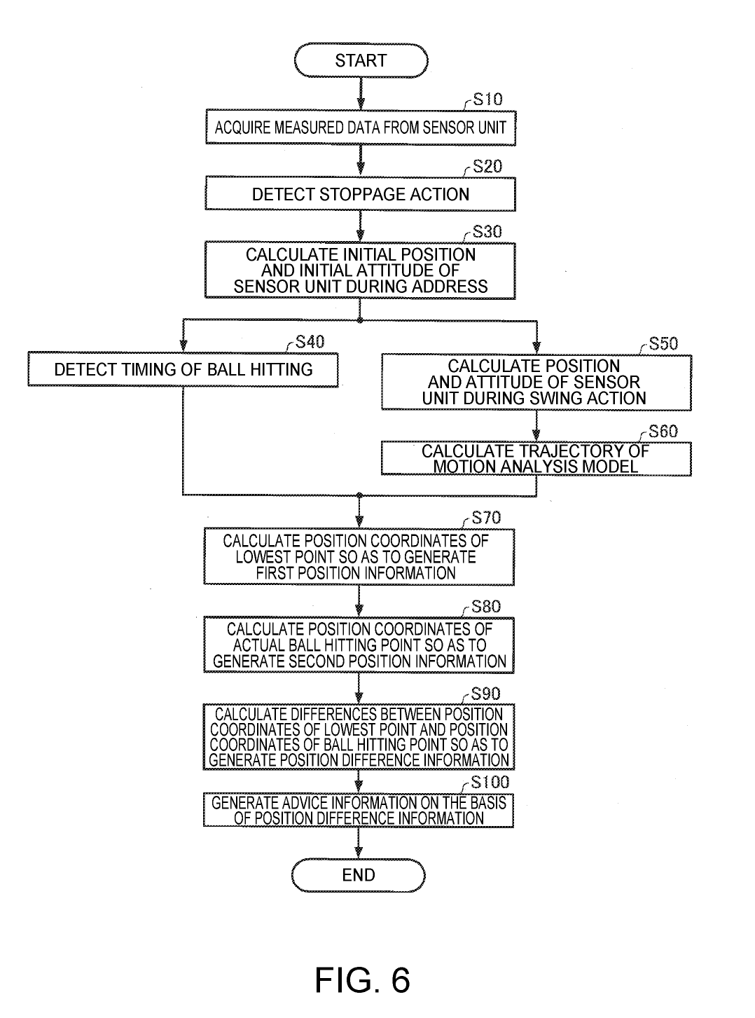

FIG. 6 is a flowchart illustrating examples of procedures of an advice information generation process performed by the processing section 200 in the present embodiment.

As illustrated in FIG. 6, first, the processing section 200 acquires measured data from the sensor unit 10 (step S10). If initial measured data in a swing action (also including a stoppage action) of the subject 2 is acquired in step S10, the processing section 200 may perform processes in step S20 and the subsequent steps in real time, and may perform the processes in step S20 and the subsequent steps after acquiring some or all of a series of measured data in the swing action of the subject 2 from the sensor unit 10.

Next, the processing section 200 detects a stoppage action (address action) of the subject 2 (the action in step S1 in FIG. 4) using the measured data acquired from the sensor unit 10 (step S20). In a case where the process is performed in real time, when the stoppage action (address action) is detected, the processing section 200 may output, for example, a predetermined image or sound, or may turn on an LED provided in the sensor unit 10, so as to notify the subject 2 of detection of the stoppage state, and the subject 2 may start a swing after checking the notification.

Next, the processing section 200 calculates an initial position and an initial attitude of the sensor unit 10 during address of the subject 2 using the measured data acquired from the sensor unit 10 (step S30). For example, the processing section 200 sets an initial position of the sensor unit 10 to the origin of the XYZ coordinate system, and specifies a direction of the gravitational acceleration direction on the basis of the acceleration data measured by the sensor unit 10 so as to calculate an initial attitude in the XYZ coordinate system.

Next, the processing section 200 detects a timing at which the subject 2 has hit the ball using the measured data (the acceleration data or the angular velocity data) acquired from the sensor unit 10 (S40). Since considerably large acceleration or angular velocity is applied to the sensor unit 10 during ball hitting (during impact), the processing section 200 can detect a timing at which the subject 2 has hit the ball using the measured data from the sensor unit 10.

The processing section 200 performs a process (S50) of calculating a position and an attitude of the sensor unit 10 during swing action of the subject 2, and a process (step S60) of calculating a trajectory of the motion analysis model on the basis of changes in the position and the attitude of the sensor unit 10, in parallel to the process in step S40. The processing section 200 calculates a position by integrating the acceleration data measured by the sensor unit 10, calculates an attitude by performing rotation calculation using the angular velocity data measured by the sensor unit 10, and calculates a trajectory of the motion analysis model using the position and the attitude of the sensor unit 10, specification information of the golf club 3, an installation position of the sensor unit 10, feature information of the subject 2, and the like.

Next, the processing section 200 obtains a trajectory of the head of the golf club 3 on the basis of the trajectory of the motion analysis model during swing, and calculates position coordinates of the lowest point of the head so as to generate the first position information (S70).

Next, the processing section 200 calculates position coordinates of an actual ball hitting point on the basis of the trajectory of the motion analysis model and the ball hitting time (impact time), so as to generate the second position information (S80).

Next, the processing section 200 calculates differences between the position coordinates of the lowest point of the head of the golf club 3 and the position coordinates of the ball hitting point using the first position information and the second position information, so as to generate the position difference information (S90).

Finally, the processing section 200 generates advice information regarding an address position of the subject 2 for causing an actual ball hitting point to become the lowest point using the position difference information (S100).

In the flowchart of FIG. 6, order of the respective steps may be changed as appropriate within an allowable range.

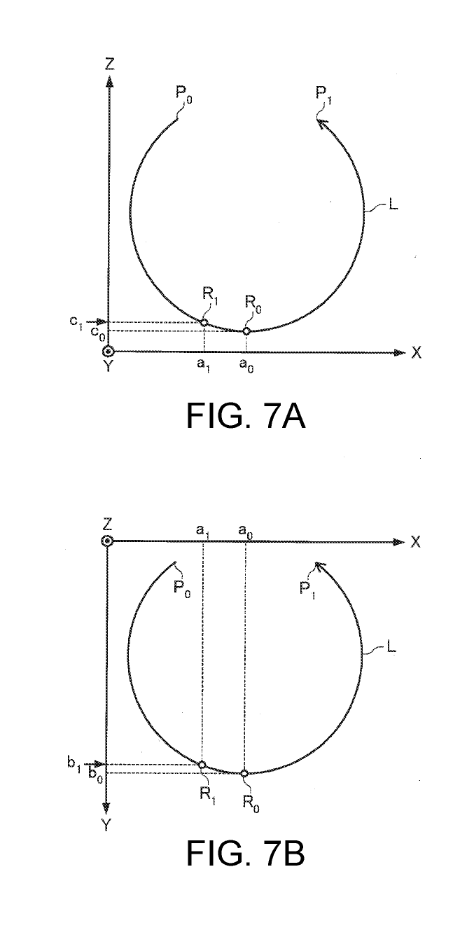

FIGS. 7(A) and 7(B) are diagrams illustrating an example of a relationship between a trajectory of the head of the golf club 3 and an actual ball hitting point from a down-swing to a follow-swing when a right-handed subject 2 performs a swing. FIG. 7(A) is a diagram in which a trajectory of the golf club 3 is projected onto an XZ plane, and FIG. 7(B) is a diagram in which the trajectory of the golf club 3 is projected onto an XY plane. In FIGS. 7(A) and 7(B), a curve L with an arrow indicates a trajectory of the head of the golf club 3, a starting point P₀ of the curve L is a starting point of the down-swing, and an ending point P₁ of the curve L is an ending point of the follow-swing. In addition, a point R₀ is the lowest point (a position where a Z coordinate is the minimum) of the curve L, and a point R₁ is an actual ball hitting point. If XYZ coordinates of the lowest point R₀ are (a₀,b₀,c₀), and XYZ coordinates of the actual ball hitting point R₁ are (a₁,b₁,c₁), differences between the position coordinates of the lowest point R₀ and the position coordinates of the actual ball hitting point R₁ are (a₀-a₁, b₀-b₁, c₀-c₁). In the examples illustrated in FIGS. 7(A) and 7(B), after the down-swing is started, a time point of reaching the actual ball hitting point R₁ is earlier than a time point at which the head of the golf club 3 reaches the lowest point R₀, and a relationship of a₀-a₁>0 and c₀-c₁<0 is satisfied. In FIG. 7(B), the Z coordinate is the minimum lowest point R₀, and the Y coordinate is the maximum, but this relationship cannot be said to be established at all times. In cases of FIGS. 7(A) and 7(B), if the subject 2 moves in a positive direction of the X axis by a₀-a₁, and moves in a positive direction of the Y axis by b₀-b₁, so as to reach a certain position, and performs exactly the same swing at the position, an actual ball hitting point matches the lowest point (ideal ball hitting point). Therefore, the processing section 200 may generate advice information for advising the subject 2 to perform address at a position obtained by moving to the left by a₀-a₁ and by stepping forward by b₀-b₁.

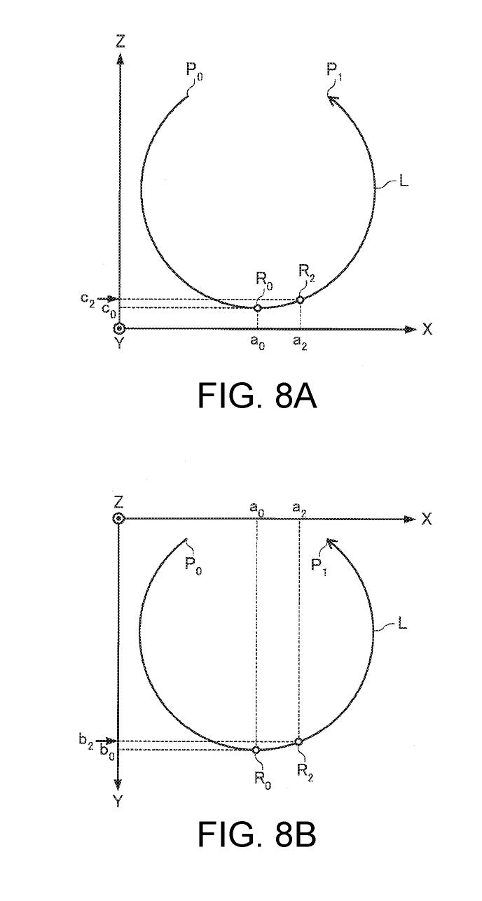

FIGS. 8(A) and 8(B) are diagrams illustrating another example of a relationship between a trajectory of the head of the golf club 3 and an actual ball hitting point from the down-swing to the follow-swing when the right-handed subject 2 performs a swing. FIG. 8(A) is a diagram in which a trajectory of the golf club 3 is projected onto the XZ plane, and FIG. 8(B) is a diagram in which the trajectory of the golf club 3 is projected onto the XY plane. In FIGS. 8(A) and 8(B), a curve L with an arrow indicates a trajectory of the head of the golf club 3, a starting point P₀ of the curve L is a starting point of the down-swing, and an ending point P₁ of the curve L is an ending point of a follow-swing. In addition, a point R₀ is the lowest point (a position where a Z coordinate is the minimum) of the curve L, and a point R₂ is an actual ball hitting point. If XYZ coordinates of the lowest point R₀ are (a₀,b₀,c₀), and XYZ coordinates of the actual ball hitting point R₂ are (a₂,b₂,c₂), differences between the position coordinates of the lowest point R₀ and the position coordinates of the actual ball hitting point R₂ are (a₀-a₂, b₀-b₂, c₀-c₂). In the examples illustrated in FIGS. 8(A) and 8(B), after the down-swing is started, a time point of reaching the actual ball hitting point R₂ is later than a time point at which the head of the golf club 3 reaches the lowest point R₀, and a relationship of a₀-a₂<0 and c₀-c₁<0 is satisfied. In FIG. 8(B), the Z coordinate is the minimum lowest point R₀, and the Y coordinate is the maximum, but this relationship cannot be said to be established at all times. In cases of FIGS. 8(A) and 8(B), if the subject 2 moves in a negative direction of the X axis by a₂-a₀, and moves in a positive direction of the Y axis by b₀-b₂, so as to reach a certain position, and performs exactly the same swing at the position, an actual ball hitting point matches the lowest point (ideal ball hitting point). Therefore, the processing section 200 may generate advice information for advising the subject 2 to perform address at a position obtained by moving to the right by a₂-a₀ and by stepping forward by b₀-b₁.

### [Impact Detection Process]

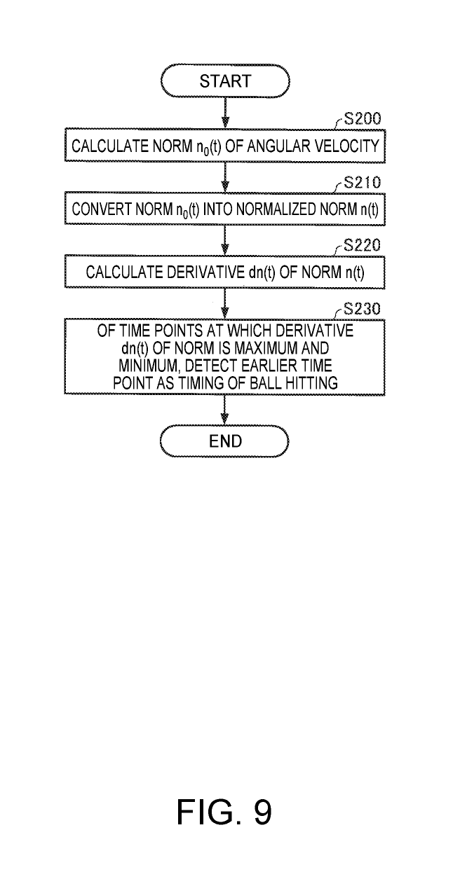

FIG. 9 is a flowchart illustrating examples of procedures of a process (the process in step S40 in FIG. 6) of detecting a timing at which the subject 2 has hit the ball.

As illustrated in FIG. 9, first, the processing section 200 calculates a value (an example of a combined value of outputs from the inertial sensor) of the norm n₀(t) of angular velocity at each time point t using the acquired angular velocity data (angular velocity data for each time point t) (S200). For example, if the angular velocity data items at the time point t are respectively indicated by x(t), y(t), and z(t), the norm n₀(t) of the angular velocity is calculated according to the following Equation (1).

[Equation 1]

n₀(t)=\sqrt{x(t)²+y(t)²+z(t)²} (1)

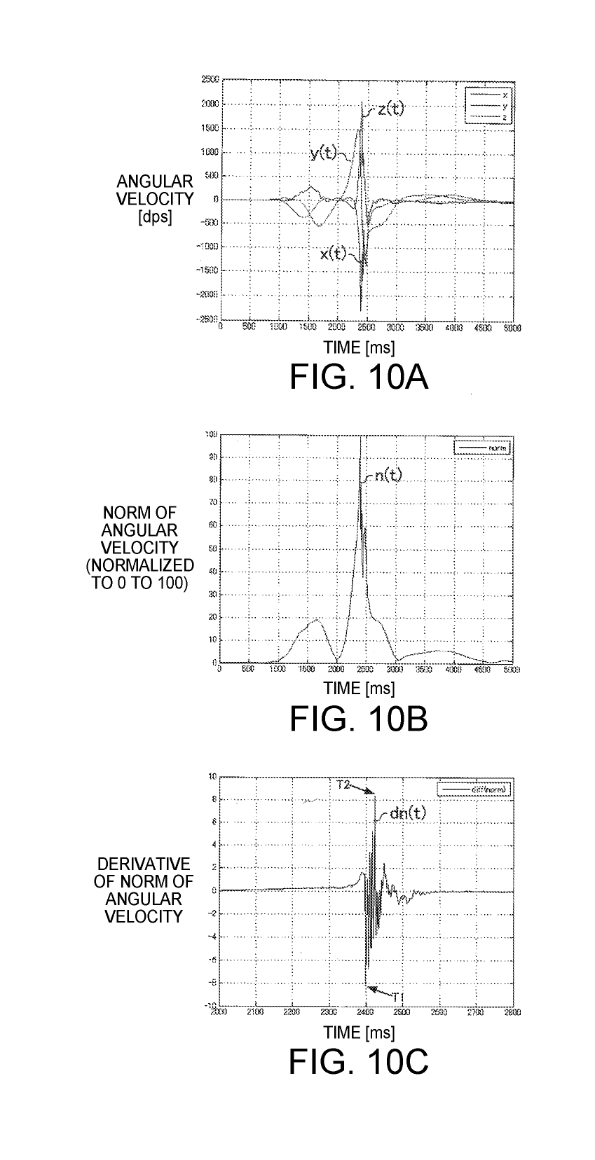

FIG. 10(A) illustrates examples of three-axis angular velocity data items x(t), y(t) and z(t) obtained when the subject 2 hits the golf ball 4 by performing a swing. In FIG. 10(A), a transverse axis expresses time (msec), and a longitudinal axis expresses angular velocity (dps).

Next, the processing section 200 converts the norm n₀(t) of the angular velocity at each time point t into a norm n(t) which is normalized (scale-conversion) within a predetermined range (S210). For example, if the maximum value of the norm of the angular velocity in an acquisition period of measured data is max(n₀), the norm n₀(t) of the angular velocity is converted into the norm n(t) which is normalized within a range of 0 to 100 according to the following Equation (2).

$$\begin{matrix}[ Equation 2 ] & \\ n ( t ) = \frac{100 \times {n}_{0} ( t )}{max ( {n}_{0} )} & ( 2 )\end{matrix}$$

FIG. 10(B) is a diagram in which the norm n₀(t) of the three-axis angular velocities is calculated according to Equation (1) using the three-axis angular velocity data items x(t), y(t) and z(t) in FIG. 10(A), and then the norm n(t) normalized to 0 to 100 according to Equation (2) is displayed in a graph. In FIG. 10(B), a transverse axis expresses time (msec), and a longitudinal axis expresses a norm of the angular velocity.

Next, the processing section 200 calculates a derivative dn(t) of the normalized norm n(t) at each time point t (S220). For example, if a cycle for measuring three-axis angular velocity data items is indicated by Δt, the derivative (difference) dn(t) of the norm of the angular velocity at the time point t is calculated using the following Equation (3).

[Equation 3]

dn(t)=n(t)−n(t−Δt) (3)

FIG. 10(C) is a diagram in which the derivative dn(t) is calculated according to Equation (3) on the basis of the norm n(t) of the three-axis angular velocities, and is displayed in a graph. In FIG. 10(C), a transverse axis expresses time (msec), and a longitudinal axis expresses a derivative value of the norm of the three-axis angular velocities. In FIGS. 10(A) and 10(B), the transverse axis is displayed at 0 seconds to 5 seconds, but, in FIG. 10(C), the transverse axis is displayed at 2 seconds to 2.8 seconds so that changes in the derivative value before and after ball hitting can be understood.

Finally, of time points at which a value of the derivative dn(t) of the norm becomes the maximum and the minimum, the processing section 200 detects the earlier time point as a ball hitting timing (S230). It is considered that a swing speed is the maximum at the moment of hitting a ball in a typical golf swing. In addition, since it is considered that a value of the norm of the angular velocity also changes according to a swing speed, a timing at which a derivative value of the norm of the angular velocity is the maximum or the minimum (that is, a timing at which the derivative value of the norm of the angular velocity is a positive maximum value or a negative minimum value) in a series of swing actions can be captured as a timing of ball hitting (impact). Since the golf club 3 vibrates due to ball hitting, a timing at which a derivative value of the norm of the angular velocity is the maximum and a timing at which a derivative value of the norm of the angular velocity is the minimum may occur in pairs, and, of the two timings, the earlier timing may be the moment of ball hitting. Therefore, for example, in the graph of FIG. 10(C), of T1 and T2, T1 is detected as a timing of ball hitting.

In a case where the subject 2 performs a swing action, a series of rhythms is expected that the subject stops the golf club at the top position, performs a down swing, hits the ball, and performs follow-through. Therefore, according to the flowchart of FIG. 9, the processing section 200 may detect candidates of timings at which the subject 2 has hit the ball, determine whether or not measured data before and after the detected timing matches the rhythms, fix the detected timing as a timing at which the subject 2 has hit the ball if the data matches the rhythms, and detect the next candidate if the data does not match the rhythms.

In the flowchart of FIG. 9, the processing section 200 detects a timing of ball hitting using the three-axis angular velocity data, but can also detect a timing of ball hitting in the same manner using three-axis acceleration data.

### [Attitude Calculation Process of Sensor Unit]

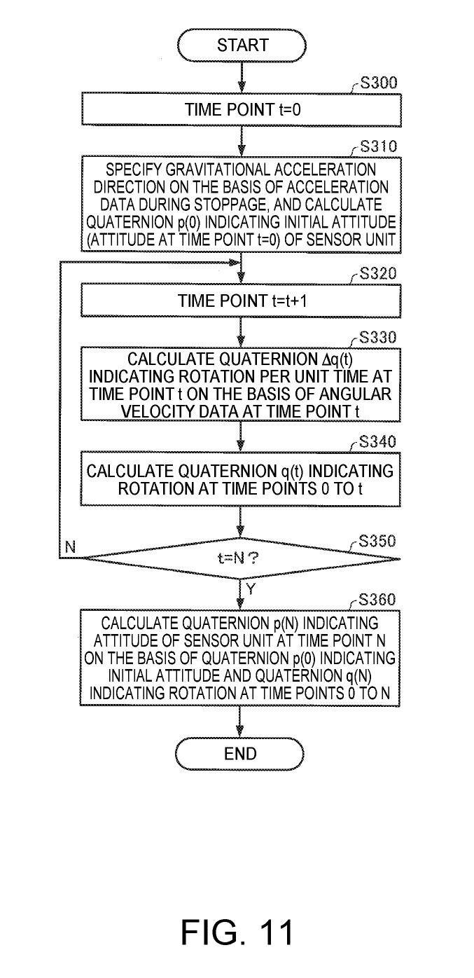

FIG. 11 is a flowchart illustrating examples of procedures of a process (some processes in step S30 and step S50 in FIG. 6) of calculating an attitude (an initial attitude and an attitude at a time point N) of the sensor unit 10.

As illustrated in FIG. 11, first, at a time point t=0 (S300), the processing section 200 specifies a direction of the gravitational acceleration on the basis of three-axis acceleration data during stoppage, and calculates a quaternion p(0) indicating an initial attitude (an attitude at the time point t=0) of the sensor unit 10 (S310).

A quaternion q indicating rotation is expressed by the following Equation (4).

[Equation 4]

q=(w,x,y,z) (4)

In Equation (4), if a rotation angle of target rotation is indicated by θ, and a unit vector of a rotation axis is indicated by (rₓ,r_{y},r_{z}), w, x, y, and z are expressed as in Equation (5).

$$\begin{matrix}[ Equation 5 ] & \\ w = cos \frac{θ}{2} , x = {r}_{x} \cdot sin \frac{θ}{2} , y = {r}_{y} \cdot sin \frac{θ}{2} , z = {r}_{z} \cdot sin \frac{θ}{2} & ( 5 )\end{matrix}$$

Since the sensor unit 10 is stopped at the time point t=0, a quaternion q(0) indicating rotation at the time point t=0 with θ=0 is expressed as in the following Equation (6) on the basis of Equation (4) obtained by assigning θ=0 to Equation (5).

[Equation 6]

q(0)=(1,0,0,0) (6)

Next, the processing section 200 updates the time point t to t+1 (S320). Here, since the time point t=0, a time point is updated to a time point t=1.

Next, the processing section 200 calculates a quaternion Δq(t) indicating rotation per unit time at the time point t on the basis of three-axis angular velocity data at the time point t (S330).

For example, if the three-axis angular velocity data at the time point t is indicated by ω(t)=(ωₓ(t),ω_{y}(t),ω_{z}(t)), the magnitude |ω(t)| of the angular velocity per sample measured at the time point t is calculated using the following Equation (7).

[Equation 7]

|ω(t)|=\sqrt{ωₓ(t)²+ω_{y}(t)²+ω_{z}(t)²} (7)

The magnitude |ω(t)| of the angular velocity indicates a rotation angle per unit time, and thus a quaternion Δq(t+1) indicating rotation per unit time at the time point t is calculated using the following Equation (8).

$$\begin{matrix} [ Equation 8 ] & \\ Δ q ( t ) = ( cos \frac{\vert ω ( t ) \vert}{2} , \frac{{ω}_{x} ( t )}{\vert ω ( t ) \vert} sin \frac{\vert ω ( t ) \vert}{2} , \frac{{ω}_{y} ( t )}{\vert ω ( t ) \vert} sin \frac{\vert ω ( t ) \vert}{2} , \frac{{ω}_{z} ( t )}{\vert ω ( t ) \vert} sin \frac{\vert ω ( t ) \vert}{2} ) & ( 8 )\end{matrix}$$

Here, since t=1, the processing section 200 calculates Δq(1) according to Equation (8) using three-axis angular velocity data ω(1)=(ωₓ(1),ω_{y}(1),ω_{z}(1)) at the time point t=1.

Next, the processing section 200 calculates a quaternion q(t) indicating rotation at time points 0 to t (S340). The quaternion q(t) is calculated according to the following Equation (9).

[Equation 9]

q(t)=q(t−1)·Δq(t) (9)

Here, since t=1, the processing section 200 calculates q(1) according to Equation (10) on the basis of q(0) in Equation (6) and Δq(1) calculated in step S330.

Next, the processing section 200 repeatedly performs the processes in steps S320 to S340 until t becomes N, and, at the time point t=N (Y in S350), calculates a quaternion p(N) indicating an attitude at the time point N on the basis of the quaternion p(0) indicating the initial attitude calculated in step S310 and the quaternion q(N) indicating the rotation at the time points t=0 to N in the previous step S340 (S360), and then finishes the process.

The processing section 200 calculates an attitude of the sensor unit 10 during ball hitting with the time point at which the subject 2 has hit as the time point N, according to the procedures of the flowchart of FIG. 11.

As described above, according to the motion analysis system 1 or the motion analysis apparatus 20 according to the invention, since advice information regarding an ideal address position based on difference information between an ideal ball hitting point and an actual ball hitting point of the head of the golf club 3 in a swing action is presented to the subject 2, the subject 2 can specifically recognize the ideal address position on the basis of the advice information. Consequently, it is possible to prompt the subject 2 to improve a golf swing.

Particularly, according to the motion analysis system 1 or the motion analysis apparatus 20 of the present embodiment, since advice information is presented with the lowest point of the head of the golf club 3 during swing action as an ideal ball hitting point, the subject 2 can recognize an ideal address position for causing an attack angle to be substantially 0. Consequently, it is possible to prompt the subject 2 to improve a swing so that a swing trajectory is horizontal during ball hitting.

According to the motion analysis system 1 or the motion analysis apparatus 20 of the present embodiment, since advice information can be generated using measured data from the sensor unit 10 attached to the golf club 3, it is not necessary to prepare a large-sized measurement tool such as a camera, and a measurement location is not greatly limited.

### 2. Modification Examples

The invention is not limited to the present embodiment, and may be variously modified within the scope of the spirit of the invention.

For example, the above-described embodiment, in a swing action of the subject 2, the lowest point (a position where the Z coordinate is smallest) is used as an ideal ball hitting point in a trajectory of the head of the golf club 3, but the invention is not limited thereto, and a position (a position where the Y coordinate is largest) which is most distant from the subject 2 in the horizontal direction may be used as an ideal ball hitting point. Alternatively, any position (for example, a position of the midpoint) between a position where the Z coordinate is smallest and a position where the Y coordinate is largest in a trajectory of the head of the golf club 3 may be used as an ideal ball hitting point. Alternatively, a position where a tangential line of a trajectory of the head of the golf club 3 is 0 in the XZ plane may be used as an ideal ball hitting point, and, in the above-described way, the motion analysis apparatus 20 can advise an address position where an attack angle is exactly 0°.

In the above-described embodiment, the motion analysis system (motion analysis apparatus) generating advice information regarding a golf swing has been exemplified, but, the invention is applicable to a motion analysis system (motion analysis apparatus) generating advice information regarding swings during stoppage of a subject in various sports such as tennis or baseball.

In the above-described embodiment, the motion analysis apparatus 20 calculates the trajectory of motion analysis model using measured data from a single sensor unit 10, but, a plurality of sensor units 10 may be attached to the golf club 3 or the subject 2, and the motion analysis apparatus 20 may calculate the trajectory of motion analysis model using measured data from the plurality of sensor units 10.

In the above-described embodiment, the sensor unit 10 and the motion analysis apparatus 20 are provided separately from each other, but may be integrated into a motion analysis apparatus which can be attached to an exercise appliance or a subject.

The above-described embodiment and respective modification examples are only examples, and the invention is not limited thereto. For example, the embodiment and the respective modification examples may be combined with each other as appropriate.

For example, the invention includes substantially the same configuration (for example, a configuration in which functions, methods, and results are the same, or a configuration in which objects and effects are the same) as the configuration described in the embodiment. The invention includes a configuration in which an inessential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

### REFERENCE SIGNS LIST

1 MOTION ANALYSIS SYSTEM
2 SUBJECT
3 GOLF CLUB
4 GOLF BALL
10 SENSOR UNIT
20 MOTION ANALYSIS APPARATUS
100 ACCELERATION SENSOR
110 ANGULAR VELOCITY SENSOR
120 SIGNAL PROCESSING SECTION
130 COMMUNICATION SECTION
200 PROCESSING SECTION
201 DATA ACQUISITION PORTION
202 FIRST POSITION INFORMATION GENERATION PORTION
203 SECOND POSITION INFORMATION GENERATION PORTION
204 POSITION DIFFERENCE INFORMATION GENERATION PORTION
205 ADVICE INFORMATION GENERATION PORTION
206 STORAGE PROCESSING PORTION
207 DISPLAY PROCESSING PORTION
208 SOUND OUTPUT PROCESSING PORTION
210 COMMUNICATION SECTION
220 OPERATION SECTION
230 ROM
240 RAM
250 RECORDING MEDIUM
260 DISPLAY SECTION
270 SOUND OUTPUT SECTION

1. A motion analysis method comprising:
generating first position information regarding an ideal ball hitting position in a swing action performed by a subject with an exercise appliance, using outputs from an inertial sensor;
generating second position information regarding a position of a hitting portion of the exercise appliance at the time of ball hitting of the subject, using outputs from the inertial sensor; and
generating position difference information regarding a difference between the ideal ball hitting position and the position of the hitting portion at the time of ball hitting, using the first position information and the second position information.

2. The motion analysis method according to claim 1,
wherein the ideal ball hitting position is a position where an altitude of the hitting portion is lowest in the swing action.

3. The motion analysis method according to claim 1,
wherein, in the generating of the first position information, trajectory information of the exercise appliance in the swing action is generated using outputs from the inertial sensor, and the first position information is generated using the trajectory information.

4. The motion analysis method according to claim 1,
wherein, in the generating of the second position information, a combined value of the outputs from the inertial sensor is calculated, and the time of ball hitting is specified on the basis of the combined value.

5. The motion analysis method according to claim 1, further comprising:
generating advice information regarding an address position of the subject for causing a position of the hitting portion at the time of ball hitting to become the ideal ball hitting position, using the position difference information.

6. The motion analysis method according to claim 1,
wherein the inertial sensor is attached to the exercise appliance.

7. The motion analysis method according to claim 1,
wherein the exercise appliance is a golf club.

8. A motion analysis apparatus comprising:
a first position information generation portion generating first position information regarding an ideal ball hitting position in a swing action performed by a subject with an exercise appliance, using outputs from an inertial sensor;
a second position information generation portion generating second position information regarding a position of a hitting portion of the exercise appliance at the time of ball hitting of the subject, using outputs from the inertial sensor; and
a position difference information generation portion generating position difference information regarding a difference between the ideal ball hitting position and the position of the hitting portion at the time of ball hitting, using the first position information and the second position information.

9. A motion analysis system comprising:
the motion analysis apparatus according to claim 8; and
the inertial sensor.

10. A program causing a computer to execute:
generating first position information regarding an ideal ball hitting position in a swing action performed by a subject with an exercise appliance, using outputs from an inertial sensor;
generating second position information regarding a position of a hitting portion of the exercise appliance at the time of ball hitting of the subject, using outputs from the inertial sensor; and
generating position difference information regarding a difference between the ideal ball hitting position and the position of the hitting portion at the time of ball hitting, using the first position information and the second position information.
